(19) United States
(12) Patent Application Publication
(10) Pub. No.: US 2022/0027822 A1
(43) Pub. Date: Jan. 27, 2022

(54) METHOD, APPARATUS, ELECTRONIC DEVICE, AND COMPUTER-READABLE STORAGE MEDIUM FOR DISTRIBUTING ORDERS

(71) Applicant: BEIJING DIDI INFINITY TECHNOLOGY AND DEVELOPMENT CO., LTD., Beijing (CN)

(72) Inventors: Zhiwei QIN, Mountain View, CA (US); Yan JIAO, Mountain View, CA (US); Minne LI, Beijing (CN); Chenxi WANG, Beijing (CN); Jun WANG, Beijing (CN); Guobin WU, Beijing (CN); Jieping YE, Tianjin (CN); Zhichen GONG, Beijing (CN); Yaodong YANG, Beijing (CN)

(73) Assignee: BEIJING DIDI INFINITY TECHNOLOGY AND DEVELOPMENT CO., LTD., Beijing (CN)

(21) Appl. No.: 17/450,458

(22) Filed: Oct. 9, 2021

Related U.S. Application Data
(63) Continuation of application No. PCT/CN2020/083947, filed on Apr. 9, 2020.

(30) Foreign Application Priority Data
Apr. 9, 2019 (CN) 201910281576.2

(51) Int. Cl. G06Q 10/06; G06Q 50/30

(52) U.S. Cl. CPC G06Q 10/06315; G06Q 50/30

(57) ABSTRACT

The present disclosure provides a method, an apparatus, an electronic device, and a computer-readable storage medium for distributing orders. The method may include obtaining attribute information of a service provider and order information of associated orders received by the service provider; obtaining a degree of association between the service provider and each of the associated orders by inputting the attribute information and the order information of the associated orders into an order distribution strategy network; and determining a distribution order for the service provider based on the degrees of association. According to the embodiments of the present disclosure, response rates of the service provider to the orders may be improved.

### CROSS-REFERENCE TO RELATED APPLICATIONS

This application is a Continuation of PCT Application No. PCT/CN2020/083947, filed on Apr. 9, 2020, which claims priority of Chinese Patent Application No. 201910281576.2, filed on Apr. 9, 2019, the contents of each of which are hereby incorporated by reference.

### TECHNICAL FIELD

The present disclosure generally relates to the field of data processing, and in particular, relates to a method, an apparatus, an electronic device, and a computer-readable storage medium for distributing orders.

### BACKGROUND

With the rapid development of automobile electronic technology, more and more people are choosing to travel via taxis, hailed private cars, etc. Such transportation means play an irreplaceable role in people's daily life, and bring about great convenience to people's daily lives and transportation.

As society further advances, traditional taxis fail to accommodate people's demands on traveling. For accommodation of user demands, online-car hailing became available. In this way, a user can reserve a desired vehicle via a transportation service software.

With the increase of the number of taxis and private cars that provide services, a conventional online-car hailing platform generally distributes orders using a greedy algorithm. The greedy algorithm generally distributes orders based on a distance between a driver and a passenger, and preferentially distributes an order to a driver who is closest to the passenger. Alternatively, the greedy algorithm ranks the orders according to values and preferentially distributes an order with a highest value to a driver within an order distribution range. However, during the order distribution using the greedy algorithm, it usually focuses only on an optimal order (e.g., an order with a closest distance, or an order with a highest value) in a current order queue, and other orders in the order queue fail to be considered. As such, during the order distribution, some service providers may have low response rates to the orders.

### SUMMARY

In view of the above, the present disclosure is intended to provide a method, an apparatus, an electronic device, and a computer-readable storage medium, for distributing orders, to solve the problem that a service provider may have a low order response rate in the related art.

In a first aspect of the present disclosure, a method for distributing orders is provided. The method includes obtaining attribute information of a service provider and order information of associated orders received by the service provider. The method may also include obtaining a degree of association between the service provider and each of the associated orders by inputting the attribute information and the order information of the associated orders into an order distribution strategy network. The method may further include determining a distribution order for the service provider based on the degrees of association. The distribution order may maximize a sum of an actual value and an estimated value of subsequent orders for the service provider.

In some embodiments, the attribute information may include location information and time information of the service provider, and the order information may include at least service start location information, service end location information, and an estimated value of a current order.

In some embodiments, the determining the distribution order for the service provider based on the degrees of association may include determining an order with a maximum degree of association as the distribution order for the service provider.

In some embodiments, the method may further include obtaining a first historical order; obtaining a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network. The first historical average action may include a supply and demand relationship, of the historical service provider, between historical service providers and historical orders at a service end location of the first historical order; and adjusting parameters of the order distribution strategy network based on the first estimated value and the first historical degree of association.

In some embodiments, the method may further include obtaining second historical orders. The second historical orders may include associated orders of the historical service provider at the service end location of the first historical order. The method may also include obtaining a second estimated value of a second historical order by inputting second historical attribute information of the historical service provider, a second historical degree of association, a historical order feature of a second historical distribution order, and a second historical average action of the historical service provider into a second action value network. The second historical average action may include a supply and demand relationship, of the historical service provider, between historical service providers and historical orders at a service end location of the second historical distribution order. The method may also include adjusting parameters of the first action value network based on the second estimated values and the first estimated value.

In some embodiments, the method may further include obtaining the parameters of the first action value network and parameters of the second action value network; weighting the parameters of the first action value network and the parameters of the second action value network; and updating the parameters of the second action value network based on a weighting result.

In some embodiments, the supply and demand relationship may be a ratio of the number of historical service providers to the number of historical orders.

In some embodiments, the first historical order may be determined based on a selection result determines by inputting a degree of association of each of first historical associated orders associated with the historical service provider into a Boltzmann selector.

In some embodiments, the associated orders may include orders within an order distribution range at a location of the service provider.

In some embodiments, the actual value may be acquired by weighting a value supposed to be allocated to the service provider, a demand potential of the service provider at the service end location of the distribution order, and a penalty against the service provider at the service end location of the distribution order.

In a second aspect of the present disclosure, an apparatus for distributing orders is provided. The apparatus may include an obtaining module, a processing module, and a distributing module. The obtaining module may be configured to obtain attribute information of a service provider and order information of associated orders received by the service provider. The processing module may be configured to determine a degree of association between the service provider and each of the associated orders by inputting the attribute information and the order information of the associated orders into an order distribution strategy network. The distributing module may be configured to determine a distribution order for the service provider based on the degrees of association. The distribution order may maximize a sum of an actual value and an estimated value of subsequent orders for the service provider.

In some embodiments, the attribute information may include location information and time information of the service provider, and the order information may include at least service start location information, service end location information, and an estimated value of a current order.

In some embodiments, the distributing module may be configured to determine an order corresponding to a maximum degree of association as the distribution order for the service provider.

In some embodiments, the apparatus may further include an adjusting module. The adjusting module may be configured to obtain a first historical order; determine a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network; and adjust parameters of the order distribution strategy network based on the first estimated value and the first historical degree of association. The first historical average action may include a supply and demand relationship, of the historical service provider, between historical service providers and historical orders at a service end location of the first historical order; In some embodiments, the adjusting module may further be configured to obtain second historical orders; determine a second estimated value of a second historical order by inputting second historical attribute information of the historical service provider, a second historical degree of association, a historical order feature of a second historical distribution order, and a second historical average action of the historical service provider into a second action value network; and adjust parameters of the first action value network based on the second estimated value and the first estimated value. The second historical orders may include associated orders of the historical service provider at the service end location of the first historical order. The second historical average action may include a supply and demand relationship, of the historical service provider, between historical service providers and historical orders at a service end location of the second historical distribution order.

In some embodiments, the adjusting module may further be configured to obtain the parameters of the first action value network and parameters of the second action value network; weight the parameters of the first action value network and the parameters of the second action value network; and update the parameters of the second action value network based on a weighting result.

In some embodiments, the supply and demand relationship may include a ratio of a count of historical service providers to a count of historical orders.

In some embodiments, the first historical order may be determined based on a selection result determined by inputting a degree of association of each of first historical associated orders associated with the historical service provider into a Boltzmann selector.

In some embodiments, the associated orders may include orders within an order distribution range at a location of the service provider.

In some embodiments, the actual value may be determined by weighting a value supposed to be allocated to the service provider, a demand potential of the service provider at the service end location of the distribution order, and a penalty against the service provider at the service end location of the distribution order.

In a third aspect of the present disclosure, an electronic device is provided. The electronic device may include a processor, a storage medium, and a bus. The storage medium may be configured to store machine-readable instructions executable by the processor. When the electronic device operates, the processor may communicate with the storage medium via the bus, and the processor may execute the machine-readable instructions to perform operations in the method according to the first aspect.

In a fourth aspect of the present disclosure, a computer-readable storage medium is provided. The computer-readable storage medium may store computer programs that, when executed by a processor, direct the processor to perform operations in the method according to the first aspect.

With the method, the apparatus, the electronic device, and the computer-readable storage medium for distributing orders, provided according to the embodiments of the present disclosure, attribute information of a service provider and order information of associated orders received by the service provider may be input to an order distribution strategy network to determine a degree of association between the service provider and each of the associated orders. Further, a distribution order for the service provider may be determined based on the degrees of association. The distribution order for the service provider determined by the order distribution strategy network may maximize a sum of current and future values for the service provider. In this way, a response rate of the service provider on an order may be improved, and a response delay duration of the order may be shortened.

For ease of understanding of the above objectives, features, and advantages of the present disclosure, the present disclosure is described hereinafter with reference to exemplary embodiments and accompanying drawings.

### BRIEF DESCRIPTION OF THE DRAWINGS

For clearer descriptions of the technical solutions according to the embodiments of the present disclosure, drawings that are to be referred to for a description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a flowchart of a first process for distributing orders according to some embodiments of the present disclosure;

FIG. 2 is a flowchart of a second process for distributing orders according to some embodiments of the present disclosure;

FIG. 3 is a schematic diagram illustrating an order distribution environment of a service provider according to some embodiments of the present disclosure;

FIG. 4 is a flowchart of a third process for distributing orders according to some embodiments of the present disclosure;

FIG. 5 is a flowchart of a fourth process for distributing orders according to some embodiments of the present disclosure;

FIG. 6 is a schematic structural diagram of an apparatus for distributing orders according to some embodiments of the present disclosure; and

FIG. 7 is a schematic structural diagram of an electronic device according to some embodiments of the present disclosure.

### DETAILED DESCRIPTION

For clearer descriptions of the objects, technical solutions, and advantages of the embodiments of the present disclosure, the following clearly and completely describes the technical solutions in the embodiments of the present disclosure with reference to the accompanying drawings of the embodiments of the present disclosure. It should be understood that the accompanying drawings attached to the present disclosure are merely intended to illustrate and describe the present disclosure, instead of limiting the scope of the present disclosure. It should be additionally understood that these drawings may not be necessarily drawn to the actual scale. The flowcharts used in the present disclosure illustrate operations performed in some embodiments of the present disclosure. It should be understood that the operations may not be performed in order. Conversely, without logic relationships and contexts, the operations may be performed in inverted order, or simultaneously. Besides, under the teaching of the present disclosure, a person skilled in the art may add one or more other operations to a flowchart, or may remove one or more operations from the flowchart.

In addition, the embodiments described herein are merely exemplary embodiments, but are not all embodiments of the present disclosure. Generally, components of the embodiments of the present disclosure described or illustrated in the drawings herein may be arranged and designed in different configurations. Therefore, the detailed descriptions of the embodiments of the present disclosure illustrated with reference to the accompanying drawings are not intended to limit the scope of the present disclosure, but are intended to merely illustrate some optional and exemplary embodiments of the present disclosure. Based on the embodiments of the present disclosure, all other embodiments derived by a person skilled in the art without any creative efforts shall fall within the scope of the present disclosure.

At present, with the increase of travel demands, a transportation service platform may generate a large number of orders anytime. However, in the platform, a count (or the number) of drivers is generally smaller than a count (or the number) of orders. That is, a supply of service providers fails to accommodate the demand of the orders. Under such supply and demand imbalance, some orders fail to be distributed to corresponding drivers, and thus passengers may have to wait for a long time period, thereby degrading the user experience. In addition, it is likely that some drivers are not distributed with orders having greater potential values, which decreases response rates of the drivers to the orders, and thus degrades the user experience of both the passengers and the drivers.

In comprehensive consideration of the demands of the platform, the passengers, and the drivers, it is of great significance to achieve smart matching between the drivers and the passengers. For improvement of the response rates of service providers to the orders, during order distribution of the transportation service platform, the transportation service platform may consider an optimal matching between a driver and an order. During order distribution, order answering action interactions are generally present among a plurality of drivers. For example, order distribution ranges of some drivers that are close to each other in terms of location may be overlapped. Such interactions may potentially affect the response rates of the drivers to the orders and supply and demand relationships of some regions. Considering the interactions among the drivers, when a count (or the number) of the drivers is constant, cooperation between the drivers may be achieved. However, when the number of drivers is huge, the response rates of the drivers to the orders may be reduced, and response time may be prolonged. Therefore, it is desirable to provide a method for distributing orders to solve the problem that the response rates of the service providers to the orders are low.

For the practice of the content of the present disclosure by a person skilled in the art, the following embodiments are given with reference to “smart order distribution” in a specific application scenario. A person skilled in the art would apply the general principles defined herein to a travel scenario, without departing from the spirit and scope of the present disclosure. Although the present disclosure is described centering around the travel scenario, it should be understood that the travel scenario is merely an exemplary embodiment.

The embodiments of the present disclosure may be applicable to a transportation service platform. The transportation service platform may be configured to provide corresponding services for users based on travel service requests received from the users. The transportation service platform may include a plurality of car-hailing systems, for example, a taxi-hailing system, a fast ride-hailing system, a tailored taxi service hailing system, a ride-sharing haling system, and the like.

According to some embodiments of the present disclosure, attribute information of a service provider and order information of associated orders received by the service provider may be input to an order distribution strategy network, and hence a degree of association between the service provider and each of the associated orders may be determined. Then, a distribution order may be determined for the service provider based on the degrees of association. The method for distributing orders of the present disclosure may not subject to the huge number of drivers, and may be applicable to a scenario where the number of drivers and the number of orders vary with time. Thus, the method for distributing orders of the present disclosure may have good robustness and timeliness. The technical solutions of the present disclosure may be described hereinafter in detail.

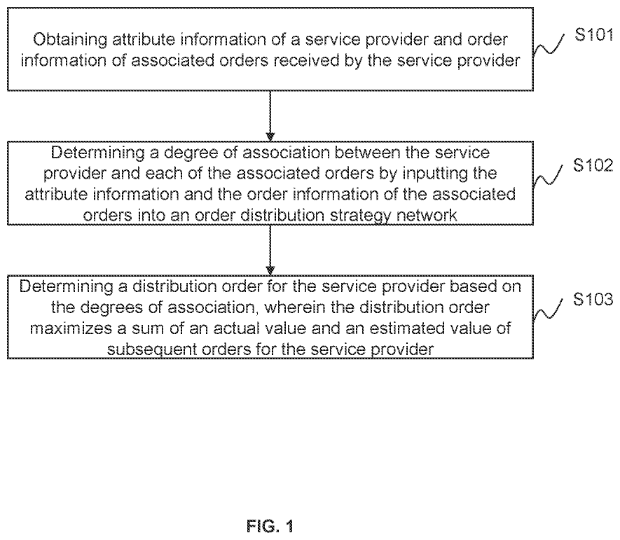

According to some embodiments of the present disclosure, a method for distributing orders is provided. The method may be applicable to a server of a transportation service platform. As illustrated in FIG. 1, the method may include the following operations.

In S101, attribute information of a service provider and order information of associated orders received by the service provider may be obtained.

The service provider may generally include a driver. The service provider in the present disclosure refers to a driver capable of providing a service for passengers in real-time in a transportation service platform. For example, the service provider may be capable of receiving real-time orders broadcast by the transportation service platform. The attribute information of the service provider may generally include location information and time information of the service provider. The location information may be positioning information acquired by a global positioning system (GPS). The time information may be time at a location of the service provider. For example, in the case that a driver is located at Q street at 16:00 on Dec. 20, 2018, the location information may be positioning information of Q street (40 degrees 54 minutes 20 seconds north latitude, and 116 degrees 23 minutes 30 seconds east longitude), and the time information may be 16:00. In some embodiments, the location information may include positioning information acquired by a Beidou Navigation Satellite System, a Global Navigation Satellite System (GLONASS), or a Galileo Satellite Navigation System. In some embodiments, the location information may also include positioning information acquired by a WiFi positioning technology, a geomagnetic positioning technology, a base station positioning technology, and the like. In some embodiments, the attribute information of the service provider may include, but is not limited to, a vehicle type, vacant seats, driver information, or the like, or any combination thereof.

The associated orders may include all orders within an order distribution range at the location of the service provider. The order distribution range may be a predetermined range, which may be defined according to actual situations. For example, the order distribution range may be defined as a circular range centered at the location of the driver and with a radius of 2 km. The order information may include at least service start location information, service end location information, and an estimated value of a current order. The service start location information may indicate a service start location of the current order. The service end location information may indicate a service end location of the current order. The estimated value of the current order may indicate an estimated value of the current order. In some embodiments, the associated orders may also include orders satisfying a condition within the order distribution range at the location of the service provider. For example, a passenger may add one or more additional conditions (e.g., a vehicle type, the number of seats, and the like) to an order when the passenger delivers the order. The orders satisfying the conditions may be orders whose additional conditions added by the passenger are satisfied by the attribute information of the service provider.

In some embodiments, in response to obtaining the location and time of the service provider, the transportation service platform server may obtain the order information of all the orders (or the orders satisfying the conditions) within the order distribution range at the location of the service provider.

In S102, a degree of association between the service provider and each of the associated orders may be determined by inputting the attribute information and the order information into an order distribution strategy network.

As used herein, the order distribution strategy network may include a perceptron neural network, for example, a multilayer perceptron (MLP) neural network. The order distribution strategy network may estimate the uncertainty of subsequent orders of the service provider by observing a state of an environment of the service provider (i.e., the orders within the order distribution range at the location of the service provider), such that a sum of an actual value of the distribution order and an estimated value of subsequent orders for the service provider may be maximized. The sum of the actual value of the distribution order and the estimated value of the subsequent orders may depend on a discount factor. The higher the discount factor, the more the estimated value of the subsequent orders needs to be considered, that is, the greater the sum of the actual value of the distribution order and the estimated value of the subsequent orders. A greater sum of the actual value and the estimated value of the subsequent orders may indicate a greater degree of association corresponding to the distribution order. The value may include an article (or goods), a worth, or the like. The degree of association may indicate a matching degree between the service provider and the associated order. The degree of association may include a sore. The higher the degree of association, the higher the matching degree between the associated order and the service provider, which means that the service provider has a high response rate for an order corresponding to a higher degree of association.

In some embodiments, the location information and the time information of the service provider may be obtained. The service start location information, the service end location information, and estimated values of the associated orders within the order distribution range at the location of the service provider may be obtained. For each of the associated orders, the degree of association between the service provider and the associated order may be determined by inputting the service start location information, the service end location information, and the estimated value of the associated order to the order distribution strategy network.

For example, the service provider may be driver A. The service provider may be at location S (positioning information) at 8:00 in the morning. Attribute information of driver A may include location S and time 8:00. Orders within an order distribution range of driver A at location S may include order T1 and order T2. Order information of order T1 may include service start location S11, service end location S12, an estimated value M1. Order information of order T2 may include service start location S21, service end location S22, and an estimated value M2. The location information and the time information of driver A, and the order information of order T1 may be input to the order distribution strategy network, and hence a degree of association R1 between driver A and order T1 may be determined. The location information, the time information, and the order information of order T2 of driver A may be input to the order distribution strategy network, and hence a degree of association R2 between driver A and order T2 may be determined.

In S103, a distribution order for the service provider may be determined based on the degrees of association. The distribution order may maximize a sum of an actual value and an estimated value of subsequent orders for the service provider.

As used herein, the actual value may indicate a value supposed to be allocated to the service provider upon completion of an order. A subsequent order may be an order after completion of the distribution order. The estimated value may be a value that the service provider is estimated to be allocated upon completion of the subsequent order. The value may be an article (or goods), a worth, or the like.

The determining the distribution order for the service provider based on the degrees of association may include:

determining an associated order corresponding to a maximum degree of association as the distribution orders for the service provider.

In some embodiments, after the degrees of association each of which is between the service provider and each of the associated orders within the order distribution range may be determined, the degrees of association may be ranked in descending order, and a top-ranked order (i.e., an order corresponding to a maximum degree of association) may be determined as the distribution order for the service provider. In some embodiments, in the case that two or more top-ranked orders have the same degree of association, one order may be randomly selected from the two or more top-ranked orders.

For example, the service provider may be driver A. An order distribution range of driver A may include four orders, T1, T2, T3, and T4, respectively. A degree of association between driver A and order T1 may be 0.8. A degree of association between driver A and order T2 may be 0.9. The degree of association between driver A and order T3 may be 0.6. The degree of association between driver A and order T4 may be 0.5. In this case, the maximum degree of association may be 0.9, which corresponds to order T1. Accordingly, order T1 may be distributed to driver A as the distribution order.

For improvement of accuracy of the order distribution strategy network, parameters of the order distribution strategy network may need to be adjusted. In some embodiments, the parameters of the order distribution strategy network may be adjusted based on current order data during order distribution. In some embodiments, the parameters of the order distribution strategy network may be adjusted based on historical order data in the transportation service platform. The specific manner for adjusting the parameters may be determined according to an actual situation, which is not limiting in the present disclosure.

Hereinafter, the process of adjusting the parameters of the order distribution strategy network may be described. In some embodiments, the parameters of the order distribution strategy network may be adjusted by gradient descent on an estimated value of an action value network and a matching degree output by the order distribution strategy network. During the adjustment of the parameters of the order distribution strategy network, for improvement of the accuracy of the order distribution strategy network, parameters of the action value network may further be adjusted, which is described in detail hereafter.

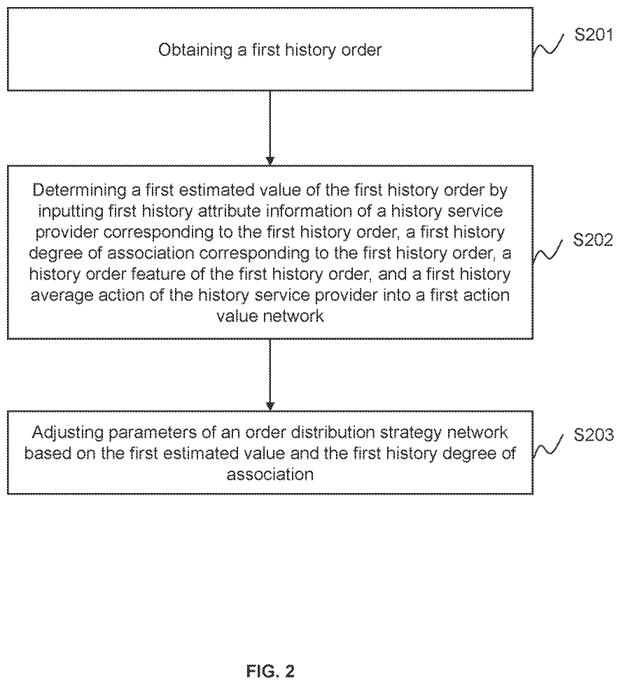

During the adjustment of the parameters of the order distribution strategy network, the method may further include the following operations referring to FIG. 2.

In S201, a first historical order may be obtained.

As used herein, the first historical order refers to an order within an order distribution range at a location of a historical service provider. In some embodiments, the location of the historical service provider may be the same as or close to (e.g., a distance between the historical service provider and the service provider being less than 100 m) the location of the service provider. In some embodiments, the time when the historical service provider is at the location of the historical service provider may be the same as (e.g., both time being 16:00) or close to (e.g., a time difference being less than 10 min) the time information of the service provider.

The first historical order may be determined based on a selection result acquired by inputting a degree of association corresponding to each of associated with the historical service provider into a Boltzmann selector.

In some embodiments, the degree of association between the historical service provider and each of the first historical associated orders acquired by the order distribution strategy network may be input to the Boltzmann selector, and hence a matching probability between the historical service provider and each of the first historical associated orders may be determined. A greater matching probability may indicate a higher matching degree between the first historical associated order and the historical service provider. A sampling operation may be performed according to a distributions output by the Boltzmann selector (e.g., extracting a greatest matching probability) to determine a corresponding first historical associated order as the first historical order. The first historical associated orders may include orders within the order distribution range at the location of the historical service provider.

The Boltzmann selector may correspond to a formula as follows:

$${π}^{i} ( {a}^{i , j} \vert {o}^{i} ) = \frac{exp ( β {μ}^{i} ( {o}^{i} , {a}^{i , j} ) )}{{\sum }_{m = 0}^{{M}_{i}} exp ( β {μ}^{i} ( {o}^{i} , {a}^{i , m} ) )} ,$$

wherein j=1, . . . , Mᵢ,
πⁱ(a^{i,j}|oⁱ) denotes a probability of a j^{th} first historical associated order of an i^{th} historical service provider, μⁱ(oⁱ,a^{i,j}) denotes a degree of association between the i^{th} historical service provider and the j^{th} first historical associated order, β denotes a scale factor, which is generally a decimal number between 0 and 1, Mⁱ denotes first historical associated orders of the i^{th} historical service provider, oⁱ denotes service start location and time of the i^{th} historical service provider in the first historical order, a^{i,j} denotes the j^{th} first historical associated order of the i^{th} historical service provider at the service start location, and a^{i,m} denotes an m^{th} associated order of the i^{th} historical service provider at the service start location.

For example, first historical associated orders of driver A1 may be denoted by T01, T02, and T03. The degree of association between driver A1 and order T01 may be denoted by R1. The degree of association between driver A1 and order T02 may be denoted by R2. The degree of association between driver A1 and order T02 may be denoted by R3. R1, R2, and R3 may be input to the Boltzmann selector respectively, and hence a matching probability G1 between driver A1 and the first historical associated order T01, a matching probability G2 between driver A1 and the first historical associated order T02, and a matching probability G3 between driver A1 and the first historical associated order T03 may be determined. In the case that G1 is the maximum matching probability, the historical associated order T01 may be the first historical order of driver A1.

In S202, a first estimated value of the first historical order may be determined by inputting first historical attribute information of a historical service provider corresponding to the first historical order, a first historical degree of association corresponding to the first historical order, a historical order feature of the first historical order, and a first historical average action of the historical service provider into a first action value network. The first historical average action may include a supply and demand relationship, of the historical service provider, between historical service providers and historical orders at a service end location of the first historical order.

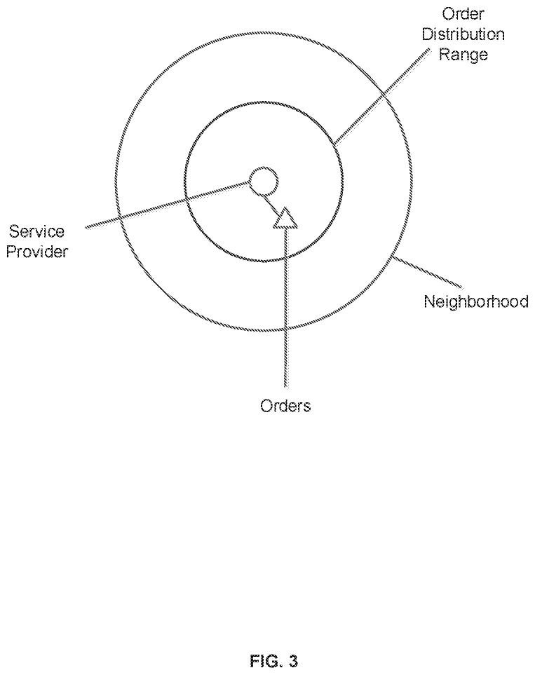

As used herein, the first historical attribute information may include location information and time information of the historical service provider upon receiving the first historical order. The first historical degree of association may include a degree of association between the historical service provider and the first historical order output by the order distribution strategy network. The historical order feature of the first historical order may include service start location information and service end location information of the first historical order. The first historical average action may indicate a supply and demand relationship at the location of the historical service provider. The first historical average action may be a ratio of a count (or the number) of historical service providers in a neighborhood of the historical service provider to a count (or the number) of historical orders within the order distribution range when the historical service provider is at the service end location of the first historical order. The neighborhood may be within a predetermined range of the location of the service provider. The predetermined range may be larger than or equal to the order distribution range. In some embodiments, in the case that the neighborhood and the order distribution range are both circulars, a radius of the neighborhood may be twice a radius of the order distribution range. Taking an order distribution environment of a single service provider as an example, details about the neighborhood and the order distribution range of the service provider the order distribution environment may refer to FIG. 3. The first action value network may be configured to estimate a value of the service provider at the service start location corresponding to the first historical order. The first action value network may include a perceptron neural network, for example, an MLP neural network.

In some embodiments, the location information and the time information of the historical service provider at the location corresponding to the first historical order, the first historical degree of association between the first historical order and the historical service provider, the service start location information and the service end location information of the first historical order, and the supply and demand relationship of the historical service provider at the service end location of the first historical order may be input to the first action value network, and hence the first estimated value of the first historical order may be determined.

For example, the first historical order may be denoted by T0. The order feature corresponding to the first historical order may include service start location S01 and service end location S02. The historical service provider may include driver A1. The degree of association between driver A1 and the first historical order may be R0. The location of driver A1 at 8:00 in the morning may be denoted by S0 (GPS information). The first historical attribute information of driver A1 may include location S0 and time 8:00. At location S02, the neighborhood of driver A1 may include N1 historical service providers. The order distribution range of driver A1 may include M1 orders. The first historical average action of driver A1 may be N1/M1. The first historical attribute information, the first historical degree of association, the order feature of the first historical order, and the first historical average action of the historical service provider may be input to the first action value network, and hence the first estimated value of driver A1 upon receiving the first historical order T0 may be determined.

In S203, parameters of the order distribution strategy network may be adjusted based on the first estimated value and the first historical degree of association.

In some embodiments, gradient descent iteration may be performed on the first estimated value and the first historical degree of association according to a small-scale gradient descent algorithm, such that the parameters of the order distribution strategy network may be adjusted.

A gradient between a first estimated value and a first historical degree of association may be determined using the formula as follows:

∇_{θ}_{ⁱ}J(θⁱ)=E_{o,a}[∇_{θ}_{ⁱ}μⁱ(aⁱ|oⁱ)∇ₐ_{ⁱ}Q(oⁱ,(āⁱ,aⁱ))]

wherein ∇_{θ}_{ⁱ}J(θⁱ) denotes a gradient of an output result of the order distribution strategy network of the i^{th} historical service provider, ∇_{θ}_{ⁱ}μⁱ(aⁱ|oⁱ) denotes a gradient of a first degree of association corresponding to a first historical order of the i^{th} historical service provider, ∇ₐ_{ⁱ}Q(oⁱ,(āⁱ,aⁱ)) denotes a gradient of a first estimated value corresponding to the first historical order of the i^{th} historical service provider, aⁱ denotes an associated order of the i^{th} historical service provider at a service end location of the first historical order, of denotes a service start location and time of the i^{th} historical service provider in the first historical order, and āⁱ denotes a first historical average action of the i^{th} historical service provider.

During adjustment of the parameters of the order distribution strategy network, gradient descent may need to be performed on the estimated value of the first action value network and the output result of the order distribution strategy network. Accuracy of the estimated value determined by the first action value network may directly affect the accuracy of the adjustment of the parameters of the order distribution strategy network, and improvement of estimation accuracy of the first action value network may improve the accuracy of the order distribution strategy network.

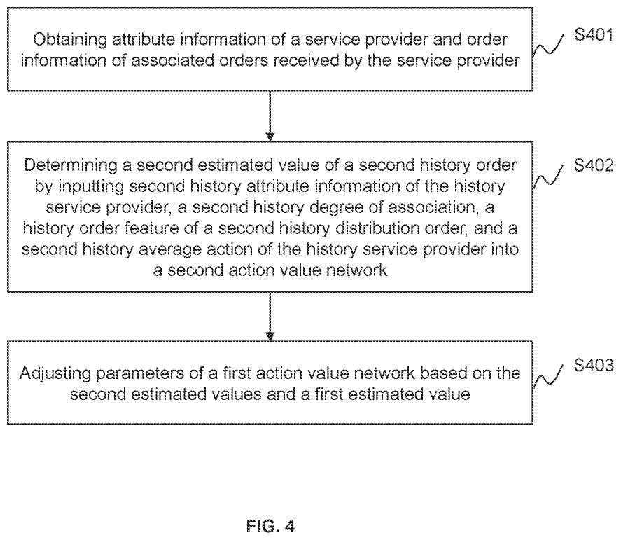

During the adjustment of the parameters of the order distribution strategy network, the method further includes the following operations as illustrated in FIG. 4.

In S401, second historical orders may be obtained. The second historical orders may include associated orders of the historical service provider at the service end location of the first historical order.

As used herein, the second historical orders may include orders within the order distribution range of the historical service provider at the service end location of the first historical order.

In S402, a second estimated value of the second historical order may be determined by inputting second historical attribute information of the historical service provider, a second historical degree of association, a historical order feature of a second historical distribution order, and a second historical average action of the historical service provider into a second action value network. The second historical average action may include a supply and demand relationship, of the historical service provider, between historical service providers and historical orders at a service end location of the second historical distribution order.

As used herein, the second historical attribute information may include location information and time information of the historical service provider at the service end location of the first historical order. The second historical degree of association may include a degree of association between the historical service provider and each of the second historical orders output by the order distribution strategy network. The second historical distribution order may include a service finalization order of the historical service provider. The historical order feature of the second historical distribution order may include service start location information and service end location information of the second historical distribution order. The second historical average action may indicate a supply and demand relationship at the location of the historical service provider. The second historical average action may be a ratio of a count (or the number) of historical service providers in a neighborhood of the historical service provider to a count (or the number) of historical orders within the order distribution range when the historical service provider is at the service end location of the second historical distribution order. The second action value network may be configured to estimate a value that the historical service provider is supposed to be allocated when the historical service provider is at the service start location corresponding to the second historical distribution order. The second action value network may include a perceptron neural network, for example, an MLP neural network.

In some embodiments, the location information and the time information of the historical service provider at the location, the second historical degree of association between each of the second historical orders and the historical service provider, the service start location information and the service end location information of the second historical distribution order, and the supply and demand relationship of the historical service provider at the service end location of the second historical distribution order may be input to the second action value network, and hence the second estimated value of the second historical order may be determined.

For example, the second historical distribution order may be denoted by T00. The order feature corresponding to the second historical distribution order may include service start location S001 and service end location S002. The historical service provider may include driver A1. The second historical orders of driver A1 within the order distribution range may be denoted by T001, T002, and T003. A degree of association between driver A1 and the second historical distribution order may be R0. The second degree of association between driver A1 and the second historical order T001 may be denoted by R11. The second degree of association between driver A1 and the second historical order T002 may be denoted by R12. The second degree of association between driver A1 and the second historical order T003 may be denoted by R13. The location of driver A1 at 9:00 in the morning may be denoted by SOC (GPS information). The second historical attribute information of driver A1 may include location S00 and time 9:00. At location S002, the neighborhood of driver A1 may include N2 historical service providers. The order distribution range of driver A1 may include M2 orders. The first historical average action of driver A1 may be N2/M2. F each of the second historical orders, the second historical attribute information of driver A1, the second historical degree of association of driver A1, and the order feature of the second historical distribution order, and the second historical average action of the historical service provider may be input to the second action value network, and hence the second estimated value corresponding to driver A1 serving the second historical order may be determined. Accordingly, the second estimated values corresponding to the second historical order T001, the second historical order T002, and the second historical order T003 may be determined.

In S403, parameters of the first action value network may be adjusted based on the second estimated values and the first estimated value.

In some embodiments, a weighted average value may be determined by weighting the second estimated values of the second historical orders. The weighted average value, an actual value of the historical order, and the first estimated value of the first historical order may be input to a loss function, the parameters of the first action value network may be adjusted such that the loss function is minimized. The weighting the second estimated values of the second historical orders may include determining an average value of a sum of the second estimated values.

The actual value of the first historical order may be a weighted value by weighting a value supposed to be allocated to the first historical order, a demand potential of the first historical order at the service end location, and a penalty against serving the first historical order. That is, a sum of products of the value supposed to be allocated, the demand potential, and the penalty with their corresponding weights may be determined, and the sum may be designated as the actual value of the first historical value. The weights of the value supposed to be allocated, the demand potential, and the penalty may be set according to the actual situations. For example, the weight of the value supposed to be allocated may be set to 1, the weight of the demand potential may be set to 1, 3, 5, 10, 20, or the like, and the weight of the penalty may be set to 3, 5, 8, or the like.

The value supposed to be allocated to the first historical order may be an actual value of the historical service provider (e.g., an income supposed to be gained by the historical service provider upon completion of the first historical order). The potential of the first historical order at the service end location may be a difference between a count (or the number) of orders within the order distribution range and a count of (or the number) of historical service providers in the neighborhood when the historical service provider is at the service end location of the first historical order. The penalty for time-out of order answering may be determined based on a distance between the historical service provider and the service start location of the first historical order.

For example, as described in connection with S302, the first historical order may be denoted by T0. The actual income of order T0 (the actual value) may be 50. The order feature corresponding to the first historical order may include service start location S01 and service end location S02. The historical service provider may include driver A1. A distance between driver A1 and S01 may be 1.5 km. In this case, the penalty for time-out of order answering may be −1.5. When driver A2 is at location S02, the number of service providers in the neighborhood of driver A1 may be 5, and the number of orders within the order distribution range may be 7. The demand potential of driver A1 may be 7−5=2. A weight of the value supposed to be allocated may be 1, a weight of the demand potential may be 1, and a weight of the penalty for time-out of order answering may be 10. The actual value of driver A1 upon completion of the first historical order may be 50+2−15=37.

During the adjustment of the parameters of the first action value network, the parameters may be adjusted by adjusting a loss between a learning objective and the estimated value of the first historical order. The loss function may include a formula as follows:

L(ϕⁱ)=E_{o,a,r,o′}[(rⁱ+γ\dot{v}_{MF}ⁱ(o′ⁱ)−Q(oⁱ,(āⁱ,aⁱ)))²],

wherein

\dot{v}_{MF}ⁱ(o′ⁱ)=Σ_{a′}_{ⁱ}πⁱ(a′ⁱ|o′ⁱ)E_{ā}_{ⁱ}_{,a′}_{^{−i}}_{˜π′}_{^{−i}}[\dot{Q}ⁱ(o′ⁱ,(ā′ⁱ,a′ⁱ))],

where L(ϕⁱ) denotes a loss function value of the i^{th} historical service provider. rⁱ denotes the actual value of the first historical order of the i^{th} historical service provider. \dot{v}_{MF}ⁱ(o′ⁱ) denotes the average value of estimated values of the second historical orders associated with the i^{th} historical service provider. Q(oⁱ,(āⁱ,aⁱ)) denotes the estimated value of the first historical order of the i^{th} historical service provider. γ denotes the discount factor, which may be a decimal number between 0 and 1. oⁱ denotes the service start location and the time of the i^{th} historical service provider in the first historical order. aⁱ denotes the first historical order of the i^{th} historical service provider. rⁱ denotes the actual value of the first historical service of the i^{th} historical service provider. o′ⁱ denotes the service end location and time of the i^{th} historical service provider in the first historical order, āⁱ denotes the first historical average action of the i^{th} historical service provider. \dot{Q}ⁱ(o′ⁱ,(ā′ⁱ,a′ⁱ)) denotes the estimated value of the second historical order of the i^{th} historical service provider. πⁱ(a′ⁱ|o′ⁱ) denotes the probability of the second historical order of the i^{th} historical service provider output by the Boltzmann selector.

During the adjustment of the parameters of the first action value network, the sum of the actual value of the first historical order of the historical service provider and the average of the estimated values of the associated orders after completion of the first historical order may be designated as the learning objective of the estimated value of the first historical order. That is, the estimated value of the first historical order may need to be infinitely close to the learning objective. In the case that the estimated value of the first historical order is infinitely close to the learning objective (e.g., a difference between the estimated value of the first historical order and the learning objective being less than a predetermined threshold), parameters determined in such cases may be designated as the parameters of the first action value network. In this way, the estimated value determined using the first action value network may be more accurate.

During the adjustment of the parameters of the first action value network, the estimated value estimated using the second action value network needs may be used. The higher the estimation accuracy of the second action value network, the higher the accuracy of the adjusted first action value network. Therefore, during the adjustment of the parameters of the first action value network, the parameter of the second action value network may need to be adjusted simultaneously. The process of adjusting the parameters of the second action value network may be described in the following.

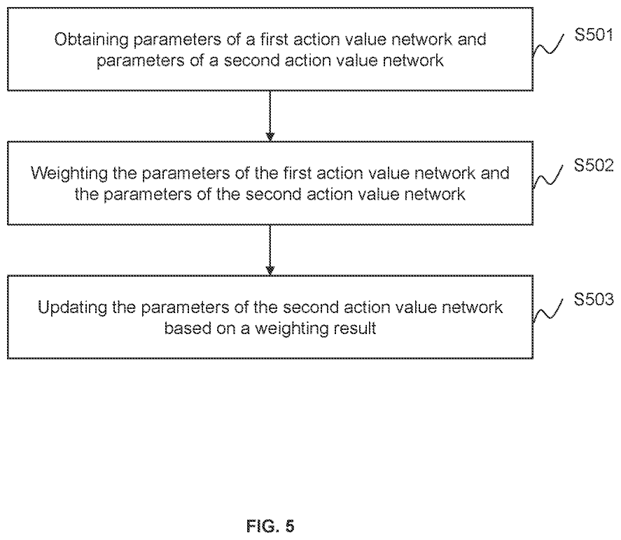

During the adjustment of the parameters of the second action value network, the method may further include the following operations referring to FIG. 5.

In S501, the parameters of the first action value network and the parameters of the second action value network may be obtained.

As used herein, during the update of the parameters of the second action value network, the parameters of the first action value network and the parameters of the second action value network at the current moment may be obtained. A count (or the number) of the parameters of the first action value network may be equal to a count (or the number) of parameters of the second action value network.

For improvement of the accuracy of the order distribution strategy network, the parameters of the first action value network may need to be adjusted in real-time, and the parameters of the second action value network may be adjusted after a preset count of adjustments have been performed on the parameters of the first action value network. In this way, on the premise of not increasing the processing workload, the accuracy of the value estimated by the first network action value may be improved.

In S502, the parameters of the first action value network and the parameters of the second action value network may be weighted.

In S503, the parameters of the second action value network are updated based on a weighting result.

Weights of the parameters of the first action value network and the parameters of the second action value network may be predefined. A weight of the first action value network may be greater than a weight of the second action value network. A sum of the weight of the first action value network and the weight of the second value network may be 1. For example, the weight of the first action value network may be defined as 0.9, and the weight of the second action value network may be defined as 0.1. In this way, the parameters of the second action network may not be reduced too much.

In some embodiments, for each of the parameters of the first action value network, a product of the parameter and its corresponding weight may be determined as a first value of the parameter. For each of the parameters of the second action value network, a product of the parameter and its corresponding weight may be determined as a second value of the parameter. A sum of each first value and its corresponding second value may be determined, and the parameters of the second action value network may be updated based on the determined sums.

For example, both the first action value network and the second action value network may include three parameters. The weight of the first action value network may be 0.9, the weight of the second action value network may be 0.1. The parameters of the first action value network may be denoted by α1, α2, and α3, respectively. The parameters of the second action value network may be denoted by γ1, γ2, and γ3, respectively. The products of the parameters of the first action value network and the weight may be 0.9*α1, 0.9*α2, and 0.9*α3, respectively. The products of the parameters of the second action value network and the weight may be 0.1*γ1, 0.1*γ2, and 0.1*γ3, respectively. In such cases, the parameter γ1 of the second action value network may be updated to 0.9*α1+0.1*γ1. The parameter γ2 of the second action value network may be updated to 0.9*α2+0.1*γ2. The parameter γ3 of the second action value network may be updated to 0.9*α3+0.1*γ3.

In some embodiments, upon completion of historical order data by the service providers of the transportation service platform, association information of the current orders of the service providers may be recorded. The association information of a current order may include historical attribution information of the service provider at a service start location of the current order, a degree of association of the current order, an order feature of the current order, an average action at a service end locations of the current order, and association information of associated orders at a service start location of a next order of the service provider. The association information of associated orders at the service start location of the next order may include historical attribute information of the service provider, a degree of association of an associated order of the next order, an order feature of the next order, and an average action at a service end location of the next order. The current order and the next order of each of the service providers may be designated as an order pair.

A part of order pairs may be selected from historical order data. The association information of the current order in an order pair may be input to the first action value network, and hence an estimated value of the current order may be determined. Association information of each associated order at a service start location of a next order in the order pair may be input to the second action value network, and hence the estimated values of the associated orders may be determined.

An average value of the estimated values of the associated orders may be determined. An actual value of the current order and the average value may be designated as learning objectives of the first action value network. The parameters of the first action value network may be adjusted such that a difference between the estimated value of the first action value network and the learning objective is minimum.

After the adjustment of the parameters of the first action value network, another part of order pairs may be selected from the historical order data. association information of a current order in an order pair of the selected another part of order pairs may be input to the first action value network, and hence an estimated value of the current order may be determined. A gradient between the estimated value of the first action value network and a matching degree of the order distribution strategy network may be reduced by using a small-scale gradient descent algorithm, so as to adjust the parameters of the order distribution strategy network.

In some embodiments, during the adjustment of the parameters of the order distribution strategy network each time, the parameters of the first action value network may be adjusted. For reduction of the data processing amount during the adjustment of the parameters of the order distribution strategy network, the parameters of the second action value network may be adjusted once, after the parameters of the first action value network have been adjusted (e.g., for 100 times). During the adjustment of the parameters of the second action value network, the parameters of the first action value network upon 100 adjustments and current parameters of the second action value network may be obtained. The parameters of the first action value network and the parameters of the second action value network may be weighted. The parameters of the second action value network may be updated based on a weighting result.

After each adjustment of the parameters of the order distribution strategy network, the order distribution strategy network may be applied to the transportation service platform for order distribution. In some embodiments, during the adjustment of the parameters of the order distribution strategy network, a large number of order distribution strategy networks may be determined. Different order distribution strategy networks may have different parameters. In order that the transportation service platform distributes more orders with high response rates to the service providers, completed orders within a plurality of order distribution cycles may be selected from the historical order data. An order distribution cycle may include a predetermined number of days, for example, 1 day, 2 days, 7 days, or the like.

Attribute information of each service provider within the plurality of order distribution cycles, order information of associated orders of the each service provider may be input to the order distribution strategy network, and hence the distribution orders of the service providers may be determined. The estimated values of the distribution orders may be estimated. Whether the estimated values of the service providers within each of the order distribution cycles converge may be determined. That is, whether a sum of the estimated values of the service providers within the order distribution cycle does not increase may be determined. In response to determining that the estimated values of the service providers within a current order distribution cycle do not converge, the current order distribution strategy network may be determined as the finally determined order distribution strategy network. An order distributed using the order distribution strategy network may have a high response rate, and the user experience of the passengers may be improved.

According to the method, the apparatus, the electronic device, and the computer-readable storage medium for distributing orders disclosed in some embodiments of the present disclosure, a degree of association between a service provider and each of associated orders received by the service provider may be determined by inputting attribute information of the service provider and order information of each of the associated orders to an order distribution strategy network. A distribution order may be determined for the service provider based on the degrees of association. The distribution order determined by the order distribution strategy network for the service provider may make that the service provider has maximum current and future values. The method may not be subject to the huge number of drivers, and can be applicable to a distribution scenario where the number of drivers and the number of orders vary with time, thus having good robustness and timeliness. By distributing orders using the order distribution strategy network, in one aspect, response rates of the service providers to the orders may be improved, and response delay durations of the orders caused by the order imbalance may be shortened; in another aspect, the user experience of the service providers may be improved.

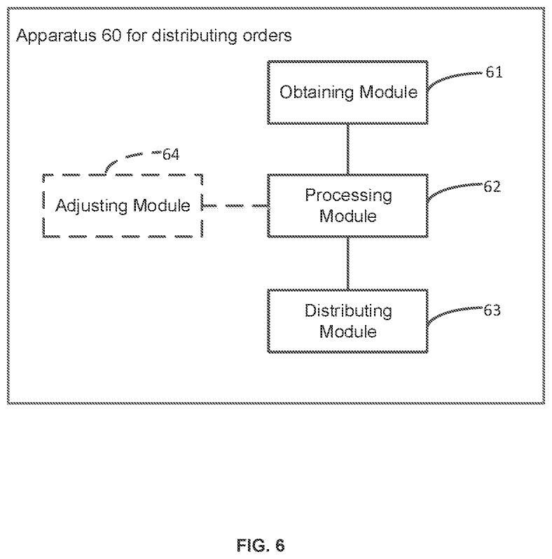

According to some embodiments of the present disclosure, an apparatus 60 for distributing orders is provided. As shown in FIG. 6, the apparatus 60 may include an obtaining module 61, a processing module 62, and a distribution module 63.

The obtaining module 61 may be configured to obtain attribute information of a service provider and order information of associated orders received by the service provider.

The processing module 62 may be configured to obtain a degree of association between the service provider and each of the associated orders by inputting the attribute information and the order information of each of the associated orders into an order distribution strategy network.

The distributing module 63 may be configured to determine a distribution order for the service provider based on the degrees of association. The distribution order may maximize a sum oft of an actual value and an estimated value of subsequent orders for the service provider.

In some embodiments, the attribute information may include location information and time information of the service provider. The order information may include at least service start location information, service end location information, and estimated values, of a current order.

In some embodiments, the distributing module 63 may be configured to determine an order corresponding to a maximum degree of association as the distribution order for the service provider.

In some embodiments, the apparatus 60 may further include an adjusting module 64.

The adjusting module 64 may be configured to obtain a first historical order. The adjusting module 64 may be configured to determine a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network. The first historical average action may include a supply and demand relationship, of the historical service provider, between historical service providers and historical orders at a service end location of the first historical order. The adjusting module 64 may be configured to adjust parameters of the order distribution strategy network based on the first estimated value and the first historical degree of association.

In some embodiments, the adjusting module 64 may further be configured to obtain second historical orders. The second historical orders may include associated orders of the historical service provider at the service end location of the first historical order. The adjusting module 64 may be configured to obtain a second estimated value of a second historical order by inputting second historical attribute information of the historical service provider, a second historical degree of association, a historical order feature of a second historical distribution order, and a second historical average action of the historical service provider into a second action value network. The second historical average action may include a supply and demand relationship, of the historical service provider, between historical service providers and historical orders at a service end location of the second historical distribution order. The adjusting module 64 may adjust parameters of the first action value network based on the second estimated values and the first estimated value.

In some embodiments, the adjusting module 64 may further be configured to obtain the parameters of the first action value network and parameters of the second action value network. The adjusting module 64 may weight the parameters of the first action value network and the parameters of the second action value network. The adjusting module 64 may update the parameters of the second action value network based on a weighting result.

In some embodiments, the supply and demand relationship may be a ratio of the number of historical service providers to the number of historical orders.

In some embodiments, the first historical order may be determined based on a selection result determined by inputting a degree of association of each of first historical associated orders associated with the historical service provider into a Boltzmann selector.

In some embodiments, the associated orders may include orders within an order distribution range at a location of the service provider.

In some embodiments, the actual value may be determined by weighting a value supposed to be allocated to the service provider, a demand potential of the service provider at the service end location of the distribution order, and a penalty against the service provider at the service end location of the distribution order.

According to some embodiments of the present disclosure, an electronic device 700 is further provided. The electronic device 700 may be a general computer or a special purpose computer. Both the general computer and the special purpose computer may be configured to perform the method for distributing orders disclosed in the present disclosure. Although a single computer is illustrated in the present disclosure, for ease of convenience, the functions of the present disclosure may be implemented in a decentralized fashion on a plurality of similar platforms, so as to balance the processing load.

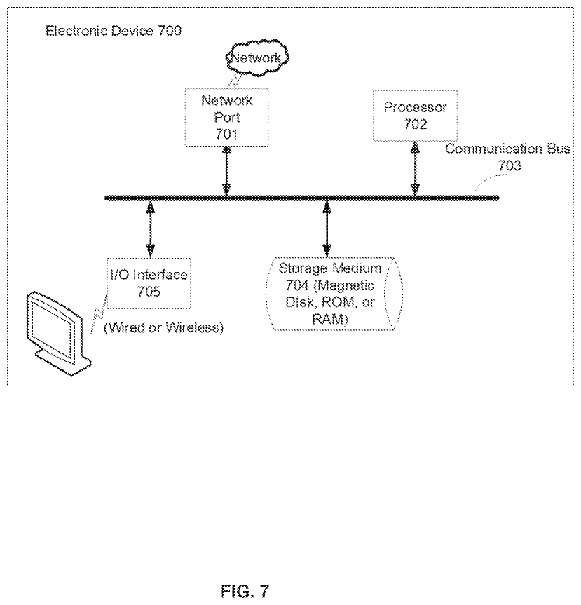

As illustrated in FIG. 7, the electronic device 700 may include a network port 701 connected to the network, one or more processors 702 configured to execute program instructions, a communication bus 703, and storage mediums 704 in different forms (e.g., a magnetic disk, a read-only memory (ROM), a random-access memory (RAM), or the like, or any combination thereof). Exemplary computer platforms may further include program instructions stored in a non-transitory storage medium including a ROM, a RAM, or the like, or any combination thereof. The program instructions may be executed to perform the method disclosed in the present disclosure. The electronic device 700 may further include an input/output (I/O) interface 705 between the computer or another input and output device (e.g., a keyboard or a display).

For ease of description, only one processor is described in the electronic device 700. However, it should be noted that the electronic device 700 disclosed in the present disclosure may also include a plurality of processors. Therefore, the operations performed by the one processor of the present disclosure may also be performed collaboratively by the plurality of processors or independently. For example, in the case that the electronic device 700 performs operations A and B, then it is understood that operations A and B may also be performed collaboratively by two different processors or independently by a single processor. For example, a first processor performs operation A, a second processor performs operation B, or the first processor and the second processor collaboratively perform operations A and B.

Hereinafter taking a single processor as an example, the processor 702 may execute instructions stored in the storage medium 704 for:

obtaining attribute information of a service provider and order information of associated orders received by the service provider;

obtaining a degree of association between the service provider and each of the associated orders by inputting the attribute information and the order information of the associated orders into an order distribution strategy network; and

determining a distribution order for the service provider based on the degrees of association, wherein the distribution order maximizes a sum of an actual value and an estimated value of subsequent orders for the service provider.

The attribute information may include location information and time information of the service provider. The order information may include at least service start location information, service end location information, and an estimated value of a current order.

In some embodiments, the processor 702 executing the instructions for determining the distribution order for the service provider based on the degrees of association may include determining an order corresponding to a maximum degree of association as the distribution order for the service provider.

In some embodiments, the processor 702 may further execute the instructions for:

obtaining a first historical order;

obtaining a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network, wherein the first historical average action includes a supply and demand relationship, of the historical service provider, between historical service providers and historical orders at a service end location of the first historical order; and

adjusting parameters of the order distribution strategy network based on the first estimated value and the first historical degree of association.

In some embodiments, the processor 702 may further execute the instructions for:

obtaining second historical orders, wherein the second historical orders include associated orders of the historical service provider at the service end location of the first historical order;

obtaining a second estimated value of a second historical order by inputting second historical attribute information of the historical service provider, a second historical degree of association, a historical order feature of a second historical distribution order, and a second historical average action of the historical service provider into a second action value network, wherein the second historical average action includes a supply and demand relationship, of the historical service provider, between historical service providers and historical orders at a service end location of the second historical distribution order; and

adjusting parameters of the first action value network based on the second estimated values and the first estimated value.

In some embodiments, the processor 702 may further execute instructions for:

obtaining the parameters of the first action value network and parameters of the second action value network;

weighting the parameters of the first action value network and the parameters of the second action value network; and

updating the parameters of the second action value network based on a weighting result.

The supply and demand relationship may include a ratio of the number of historical service providers to the number of historical orders.

The first historical order may be determined based on a selection result determined by inputting a degree of association of each of first historical associated orders associated with the historical service provider into a Boltzmann selector.

The associated orders may include orders within an order distribution range at a location of the service provider.

The actual value may be determined by weighting a value supposed to be allocated to the service provider, a demand potential of the service provider at the service end location of the distribution order, and a penalty against the service provider at the service end location of the distribution order.

Corresponding to the method for distributing orders as illustrated in FIG. 1 to FIG. 5, according to some embodiments of the present disclosure, a computer-readable storage medium is further provided. The computer-readable storage medium may store one or more computer programs. When executing the one or more computer programs by a processor, the processor may cause operations of the method for distributing orders as being performed.

In some embodiments, the computer-readable storage medium may include a general storage medium, for example, a mobile magnetic disk, a hard disk, or the like. When the one or more computer programs stored in the storage medium are executed, the method for distributing orders as described in the present disclosure may be performed, such that the problem of imbalance of order distribution in the related art is solved.

Based on the same inventive concept, according to some embodiments of the present disclosure, a computer program product is further provided. The computer program product may include a computer-readable storage medium storing one or more program codes. The one or more program codes may include instructions, which may be executed to perform the method for distributing orders as described in the present disclosure. Details may be found in embodiments of the method, which are not repeated herein.

According to the method, the apparatus, the electronic device, and the computer-readable storage medium for distributing orders disclosed in the embodiments of the present disclosure, a degree of association between a service provider and each of associated orders received by the service provider may be determined by inputting attribute information of the service provider and order information of each of the associated orders into an order distribution strategy network. A distribution order for the service provider may be determined based on the degrees of association. The distribution order determined by the order distribution strategy network for the service provider may make that the service provider has maximum current and future values. The method may not be subject to the huge number of drivers, and can be applicable to a distribution scenario where the number of drivers and the number of orders vary with time, thus having good robustness and timeliness. By distributing orders using the order distribution strategy network, in one aspect, response rates of the service providers to the orders may be improved, and response delay durations of the orders caused by the order imbalance may be shortened; in another aspect, the user experience of the service providers may be improved.

A person skilled in the art would clearly acknowledge that, for ease and brevity of description, the specific operation processes of the above-described systems and apparatuses may refer to the relevant portions of the embodiments of the method described above, which is not repeated herein. According to the several embodiments provided in the present disclosure, it should be understood that the system, apparatus, and method disclosed in the present disclosure may be achieved in other manners. The embodiments of the above-described apparatus are merely illustrative. For example, the module division is merely a logical function division and may include other divisions in actual practice. As another example, multiple modules or components may be combined or integrated into another system, or some features may be ignored or not performed. In addition, the mutual couplings, direct couplings, or communication connections displayed or discussed may be implemented through an indirect coupling or communication connection via some communication interfaces, apparatuses, or modules, which may be implemented in electronic, mechanical, or other forms.

The units which are described as separate modules may be physically separated or may be not physically separated. The components which are illustrated as modules may be or may not be physical units, i.e., the components may be located in the same position or may be distributed to a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units may be integrated into one unit.

In the case that the functions are implemented in a form of a software functional unit and sold or used as an independent product, the functions may be stored in a non-transitory computer readable storage medium executable by a processor. Based on such understanding, the technical solutions of the present disclosure essentially, or the part contributing to the related art, or all or a part of the technical solutions may be implemented in a form of a software product. The computer software product may be stored in a storage medium and include multiple instructions to cause a computer device (which may be a personal computer, a server, a network device, or the like) to perform all or some of the operations of the methods described in the embodiments of the present disclosure. The storage medium may include a U disk, a mobile hard disk, a ROM, a RAM, a magnetic disk, a compact disc read-only memory (CD-ROM), or any medium which is capable of storing program code.

The above embodiments are only exemplary embodiments of the present disclosure, which is not intended to limit the scope of the present disclosure. Various modifications and replacements readily derived by those skilled in the art under the teaching of the technical disclosure of the present disclosure shall fall within the scope of the present disclosure. Therefore, the scope of the present disclosure is subject to the appended claims.

1. A method for distributing orders, which is implemented on a computing device including at least one processor and at least one storage medium, the method comprising:
obtaining attribute information of a service provider and order information of associated orders received by the service provider;
determining a degree of association between the service provider and each of the associated orders by inputting the attribute information and the order information of the associated orders into an order distribution strategy network; and
determining a distribution order for the service provider based on the degrees of association, wherein the distribution order maximizes a sum of an actual value and an estimated value of subsequent orders for the service provider.

2. The method of claim 1, wherein the attribute information includes location information and time information of the service provider, and the order information includes at least service start location information, service end location information, and an estimated value of a current order.

3. The method of claim 1, wherein the determining a distribution order for the service provider based on the degrees of association includes:
determining an associated order corresponding to a maximum degree of association as the distribution order for the service provider.

4. The method of claim 1, further comprising:
obtaining a first historical order;
determining a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network, wherein the first historical average action includes a supply and demand relationship, of the historical service provider, between historical service providers and historical orders at a service end location of the first historical order; and
adjusting parameters of the order distribution strategy network based on the first estimated value and the first historical degree of association.

5. The method of claim 4, further comprising:
obtaining second historical orders, wherein the second historical orders include associated orders of the historical service provider at the service end location of the first historical order;
obtaining a second estimated value of a second historical order by inputting second historical attribute information of the historical service provider, a second historical degree of association, a historical order feature of a second historical distribution order, and a second historical average action of the historical service provider into a second action value network, wherein the second historical average action includes a supply and demand relationship, of the historical service provider, between historical service providers and historical orders at a service end location of the second historical distribution order; and
adjusting parameters of the first action value network based on the second estimated values and the first estimated value.

6. The method of claim 5, further comprising:
obtaining the parameters of the first action value network and parameters of the second action value network;
weighting the parameters of the first action value network and the parameters of the second action value network; and
updating the parameters of the second action value network based on a weighting result.

7. The method of claim 5, wherein the supply and demand relationship is a ratio of a count of historical service providers to a count of historical orders.

8. The method of claim 4, wherein the first historical order is determined based on a selection result determined by inputting a degree of association of each of first historical associated orders associated with the historical service provider into a Boltzmann selector.

9. The method of claim 1, wherein the associated orders include orders within an order distribution range at a location of the service provider.

10. The method of claim 1, wherein the actual value is determined by weighting a value supposed to be allocated to the service provider, a demand potential of the service provider at the service end location of the distribution order, and a penalty against the service provider at the service end location of the distribution order.

11. An electronic device for distributing orders, comprising:
at least one storage medium including instructions;
at least one processor in communication with the at least one storage medium, wherein when executing the instructions, the at least one processor is configured to direct the electronic device to:
obtain attribute information of a service provider and order information of associated orders received by the service provider;
determine a degree of association between the service provider and each of the associated orders by inputting the attribute information and the order information of the associated orders into an order distribution strategy network; and
determine a distribution order for the service provider based on the degrees of association, wherein the distribution order maximizes a sum of a maximum amount of an actual value and an estimated value of subsequent orders for the service provider.

12. The electronic device of claim 11, wherein the attribute information includes location information and time information of the service provider, and the order information includes at least service start location information, service end location information, and an estimated value of a current order.

13. The electronic device of claim 11, wherein the at least one processor is further configured to direct the electronic device to:
determine an order corresponding to a maximum degree of association as the distribution order for the service provider.

14. The electronic device of claim 11, wherein the at least one processor is further configured to direct the electronic device to:
obtain a first historical order;
determine a first estimated value of the first historical order by inputting first historical attribute information of a historical service provider corresponding to the first historical order, a first historical degree of association corresponding to the first historical order, a historical order feature of the first historical order, and a first historical average action of the historical service provider into a first action value network, wherein the first historical average action includes a supply and demand relationship, of the historical service provider, between historical service providers and historical orders at a service end location of the first historical order; and
adjust parameters of the order distribution strategy network based on the first estimated value and the first historical degree of association.

15. The electronic device of claim 14, wherein the at least one processor is further configured to direct the electronic device to:
obtain second historical orders, wherein the second historical orders include associated orders of the historical service provider at the service end location of the first historical order;
determine a second estimated value of the second historical order by inputting second historical attribute information of the historical service provider, a second historical degree of association, a historical order feature of a second historical distribution order, and a second historical average action of the historical service provider into a second action value network, wherein the second historical average action includes a supply and demand relationship, of the historical service provider, between historical service providers and historical orders at a service end location of the second historical distribution order; and
adjust parameters of the first action value network based on the second estimated values and the first estimated value.

16. The electronic device of claim 15, wherein the at least one processor is further configured to direct the electronic device to:
obtain the parameters of the first action value network and parameters of the second action value network;
weight the parameters of the first action value network and the parameters of the second action value network; and
update the parameters of the second action value network based on a weighting result.

17. (canceled)

18. The electronic device of claim 14, wherein the first historical order is determined based on a selection result determined by inputting a degree of association of each of first historical associated orders associated with the historical service provider into a Boltzmann selector.

19. The electronic device of claim 11, wherein the associated orders include orders within an order distribution range at a location of the service provider.

20. The electronic device of claim 11, wherein the actual value is determined by weighting a value supposed to be allocated to the service provider, a demand potential of the service provider at the service end location of the distribution order, and a penalty against the service provider at the service end location of the distribution order.

21. (canceled)

22. A computer-readable storage medium, storing computer programs that, when executed by a processor, direct the processor to perform a method for distributing orders, the method including:
obtaining attribute information of a service provider and order information of associated orders received by the service provider;
determining a degree of association between the service provider and each of the associated orders by inputting the attribute information and the order information of the associated orders into an order distribution strategy network; and
determining a distribution order for the service provider based on the degrees of association, wherein the distribution order maximizes a sum of an actual value and an estimated value of subsequent orders for the service provider.
